(19) United States
(12) Patent Application Publication
(10) Pub. No.: US 2006/0114046 A1
(43) Pub. Date: Jun. 1, 2006

(54) Differential clock transmission apparatus, differential clock sending apparatus, differential clock receiving apparatus and differential clock transmission method

(75) Inventor: Yasushi Mizutani, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/060,806

(22) Filed: Feb. 18, 2005

(30) Foreign Application Priority Data
Nov. 29, 2004 (JP) 2004-343280

(51) Int. Cl. G06F 1/04

(52) U.S. Cl. 327/291

(57) ABSTRACT

A differential clock transmission apparatus is adapted to convert an outgoing clock signal into a pair of differential clock signals for transmission and also convert a pair of differential clock signals into a single incoming clock signal and comprises a sending control section 11 that specifies an electric potential correction period that is a predetermined period before utilizing the incoming clock signal, a differential clock sending section 13 that converts a single outgoing clock signal into a pair of differential clock signals, an electric potential correcting section 14 that reduces the potential difference of the pair of differential clock signals within the electric potential correction period and a differential clock signal receiving section 22 that converts a pair of differential clock signals into a single incoming clock signal.

### BACKGROUND OF THE INVENTION

1. Field of the Invention

This invention relates to a differential clock transmission apparatus, a differential clock sending apparatus, a differential clock receiving apparatus and a differential clock transmission method for transmitting a high frequency clock.

2. Description of Related Art

Differential clock transmission is used in computer systems using a high frequency clock. Differential clock transmission is an operation of transmitting a pair of differential clock signals showing polarities that are inverted relative to each other by way of a pair of wires. Differential clock transmission is characterized by a strong anti-noise effect. FIG. 12 is a schematic block diagram of a known differential clock transmission apparatus, showing its configuration. Referring to FIG. 12, the illustrated known differential clock transmission apparatus comprises a clock sending side LSI 901 and a clock receiving side LSI 902. The clock sending side LSI 901 includes a sending control section 911, a clock oscillating section 12, and a differential clock sending section 13. On the other hand, the clock receiving side LSI 902 includes a differential clock receiving section 22. The clock oscillating section 12 includes a PLL (phase locked loop).

When power is supplied, the sending control section 911 resets and initializes the inside of the clock sending side LSI 901. Then, the sending control section 911 selects the frequency of the PLL of the clock oscillating section 12. The clock oscillating section 12 outputs an outgoing clock signal and the differential clock sending section 13 converts a single outgoing clock signal into a pair of differential clock signals Q′, /Q′ whereas the differential clock receiving section 22 converts a pair of differential clock signals into a single incoming clock signal.

FIG. 13 is a circuit diagram of the differential clock sending section, showing a typical configuration thereof. Referring to FIG. 13, the differential clock sending section 13 has four transistors (Tr911, Tr912, Tr913, Tr914). The transistors Tr911 and Tr913 are connected to electric potential H, which is a High potential while the transistors Tr912 and Tr914 are connected to electric potential L, which is a Low potential. When the outgoing clock signal is High, Tr911 and Tr914 are ON and Tr912 and Tr913 are OFF. Therefore Q′ is High and /Q′ is Low. When, on the other hand, the outgoing clock signal is Low, Tr912 and Tr913 are ON and Tr911 and Tr914 are OFF. Therefore, Q′ is Low and /Q′ is High. In this way, a pair of differential clock signals Q′, /Q′ showing polarities that are inverted relative to each other are output in response to an input outgoing clock signal.

However, in the case of long distance transmission of a high frequency differential clock, the waveforms of the differential clock signals are attenuated due to a high frequency loss at the time of signal propagation. Then, the differential clock signals are transposed only shallowly to give rise to duty distortions and phase shifts. Thus, as a result, problems such as a shifted timing and a lost clock can arise immediately after the start of the clock. FIG. 14 illustrates the waveforms of a pair of differential clock signals when they are input to a conventional differential clock signal receiving section. The time period since the time when the clock oscillating section 12 outputs an outgoing clock signal is referred to as clock operation period hereinafter. The waveforms are obtained by a simulation of the input waveforms of the differential clock receiving section 22 at the clock receiving side LSI 902. The potential difference between Q′ and /Q′ is large at the beginning of the clock operation period and their electric potentials change with time to prove that their duties and phases are instable.

Therefore, conventionally, various countermeasures have been taken to cope with the above-identified problems. Such countermeasures include the use of a low loss board material, controlling the drive capabilities of the output circuit by cutting any direct current and mounting an equalizer circuit for coupling the differential clock transmission apparatus and the transmission line.

Known techniques that relate to the present invention include the one disclosed in Patent Document 1 (Japanese Patent Application Laid-Open Publication No. 2002-305437 (pp. 4-9, FIG. 4). The logic circuit disclosed in the above patent document is provided with an equalizer arranged between a pair of signals, which equalizer is driven by an equalizing clock signal.

However, the above described known countermeasure technique is accompanied by various problems including high cost, the use of a complex circuit, a large area required for mounting the circuit and so on.

### SUMMARY OF THE INVENTION

In view of the above-identified problem, it is therefore the object of the present invention to provide a differential clock transmission apparatus, a differential clock sending apparatus, a differential clock receiving apparatus and a differential clock transmission method that can reduce duty distortions and phase shifts due to a high frequency long distance transmission.

In an aspect of the present invention, the above object is achieved by providing a differential clock transmission apparatus adapted to convert an outgoing clock signal into a pair of differential clock signals for transmission and also convert a pair of differential clock signals into a single incoming clock signal, the apparatus comprising: a control section that specifies an electric potential correction period that is a predetermined period before utilizing the incoming clock signal; a differential clock sending section that converts a single outgoing clock signal into a pair of differential clock signals; an electric potential correcting section that reduces the potential difference of the pair of differential clock signals within the electric potential correction period; and a differential clock signal receiving section that converts a pair of differential clock signals into a single incoming clock signal.

Preferably, in a differential clock transmission apparatus according to the invention, the electric potential correcting section includes transistors that connect the signal lines of the pair of differential clock signals and reduce the potential difference by turning ON the transistors during the electric potential correction period.

Preferably, in a differential clock transmission apparatus according to the invention, the pair of differential clock signals has two states including a first electric potential and a second electric potential lower than the first electric potential and each of the signal lines of the pair of differential clock signals in the electric potential correcting section is connected to the first electric potential and the second electric potential by way of the respective transistors so that both of the paired differential clock signals show an electric potential near the middle of the first electric potential and the second electric potential by turning OFF all the transistors during the electric potential correction period.

Preferably, in a differential clock transmission apparatus according to the invention, the pair of differential clock signals has two states including a first electric potential and a second electric potential lower than the first electric potential and each of the signal lines of the pair of differential clock signals in the electric potential correcting section is connected to the first electric potential and the second electric potential by way of the respective transistors so that both of the paired differential clock signals show an electric potential near the middle of the first electric potential and the second electric potential by turning ON all the transistors during the electric potential correction period.

In another aspect of the present invention, there is provided a differential clock sending apparatus adapted to convert an outgoing clock signal into a pair of differential clock signals and send them to an outside apparatus, the apparatus comprising: a control section that specifies an electric potential correction period that is a predetermined period before the outside apparatus utilizes the differential clock signals; a differential clock sending section that converts a single outgoing clock signal into a pair of differential clock signals; and an electric potential correcting section that reduces the potential difference of the pair of differential clock signals within the electric potential correction period.

In still another aspect of the present invention, there is provided a differential clock receiving apparatus adapted to convert a pair of differential clock signals received from the outside into a single incoming clock signal, the apparatus comprising: a control section that specifies an electric potential correction period that is a predetermined period before utilizing the incoming clock signal; an electric potential correcting section that reduces the potential difference of a pair of externally input differential clock signals within the electric potential correction period; and a differential clock signal receiving section that converts the pair of differential clock signals into a single incoming clock signal.

In a further aspect of the present invention, there is provided a differential clock transmission method adapted to convert an externally input outgoing clock signal into a pair of differential clock signals for transmission and also convert a pair of differential clock signals into a single incoming clock signal, the method comprising: specifying an electric potential correction period that is a predetermined period before utilizing the incoming clock signal; converting a single outgoing clock signal into a pair of differential clock signals; reducing the potential difference of the pair of differential clock signals within the electric potential correction period; and converting a pair of differential clock signals into a single incoming clock signal.

Preferably, in a differential clock transmission method according to the invention, the electric potential difference is reduced by connecting the signal lines of the pair of differential clock signals during the electric potential correction period.

Preferably, in a differential clock transmission method according to the invention, the pair of differential clock signals has two states including a first electric potential and a second electric potential lower than the first electric potential and each of the signal lines of the pair of differential clock signals is insulated from the first electric potential and the second electric potential so that both of the paired differential clock signals show an electric potential near the middle of the first electric potential and the second electric potential during the electric potential correction period.

Preferably, in a differential clock transmission method according to the invention, the pair of differential clock signals has two states including a first electric potential and a second electric potential lower than the first electric potential and each of the signal lines of the pair of differential clock signals is connected to the first electric potential and the second electric potential so that both of the paired differential clock signals show an electric potential near the middle of the first electric potential and the second electric potential during the electric potential correction period.

Thus, according to the invention, it is possible to stabilize the duty and the phase of the waveform of each of the differential clock signals and avoid problems such as a shifted timing and a lost clock immediately after the start of the clock without increasing the circuit size and the cost.

### BRIEF DESCRIPTION OF THE DRAWINGS

FIG. 1 is a schematic block diagram of a first embodiment of differential clock transmission apparatus according to the present invention, showing the configuration thereof;

FIG. 2 is a timing chart of the operation of generating a potential correction control signal for the purpose of the present invention;

FIG. 3 is a schematic circuit diagram of the electric potential correcting section of the first embodiment;

FIG. 4 is a schematic illustration of waveforms showing the potential difference of differential clock signals in the electric potential correction period of the first embodiment;

FIG. 5 is a timing chart of the operation of the clock sending side LSI of the first embodiment;

FIG. 6 is a schematic illustration of the waveforms of the differential clock signals input to the differential clock receiving section of the first embodiment in a clock operation period;

FIG. 7 is a schematic block diagram of a second embodiment of differential clock transmission apparatus according to the invention, showing the configuration thereof;

FIG. 8 is a schematic block diagram of a third embodiment of differential clock transmission apparatus according to the invention, showing the configuration thereof;

FIG. 9 is schematic block diagram of the corrected differential clock sending section of the third embodiment, showing the configuration thereof;

FIG. 10 is a schematic illustration of the operation of the corrected differential clock sending section of the third embodiment;

FIG. 11 is a schematic block diagram of an alternative corrected differential clock sending section of the third embodiment, showing the configuration thereof;

FIG. 12 is a schematic block diagram of a known differential clock transmission apparatus, showing the configuration thereof;

FIG. 13 is a schematic circuit diagram of the differential clock sending section, showing the configuration thereof; and

FIG. 14 is a schematic illustration of the waveforms of the differential clock signals input to the differential clock receiving section of the known differential clock transmission apparatus in a clock operation period.

### DETAILED DESCRIPTION OF THE PREFERRED EMBODIMENTS

Now, the present invention will be described in greater detail by referring to the accompanying drawings that schematically illustrate preferred embodiments of the invention.

### First Embodiment

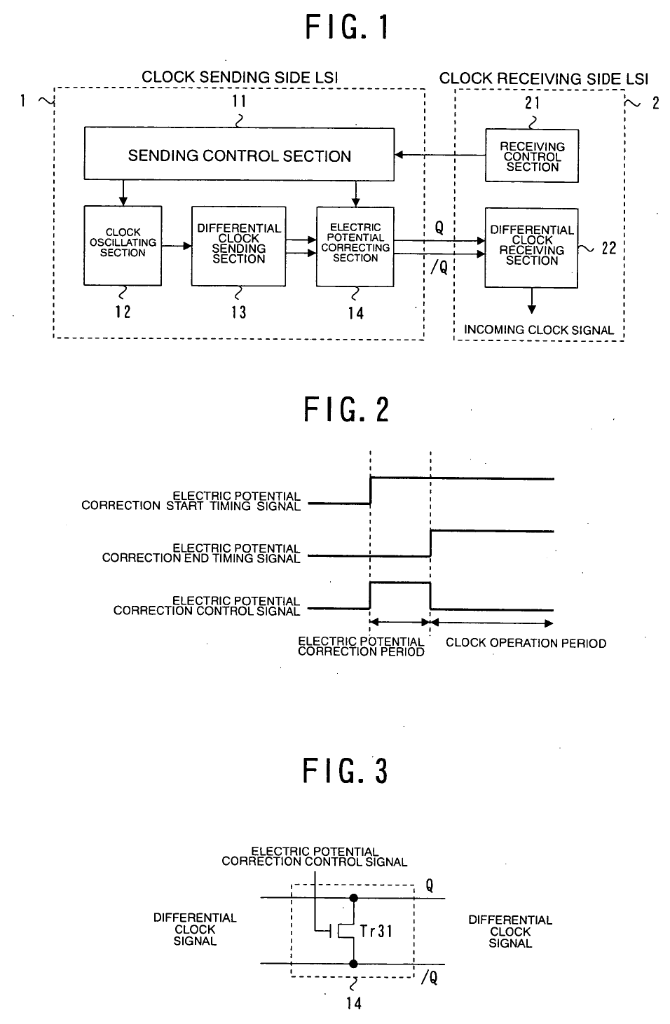

In this embodiment, the signal sending side is adapted to correct electric potentials. FIG. 1 is a schematic block diagram of the first embodiment of differential clock transmission apparatus according to the present invention, showing the configuration thereof. In FIG. 1, the components that are identical with or equivalent to the corresponding ones of FIG. 12 are denoted respectively by the same reference symbols and will not be described here any further. By comparing with the differential clock transmission apparatus of FIG. 12, it will be seen that the differential clock transmission apparatus of FIG. 1 comprises a clock sending side LSI 1 in place of the clock sending side LSI 901 of FIG. 12 and a clock receiving side LSI 2 in place of the clock receiving side LSI 902 of FIG. 12. By comparing with the clock sending side LSI 901 of FIG. 12, it will also be seen that the clock sending side LSI 1 of FIG. 1 additionally has an electric potential correcting section 14 and also has a sending control section 11 in place of the sending control section 911. Again, by comparing the clock receiving side LSI 902 of FIG. 12, it will also be seen that the clock receiving side LSI 2 of FIG. 1 additionally has a receiving control section 21.

Firstly, the electric potential correction control operation of the embodiment will be described. When power is supplied, the sending control section 11 resets the inside of the clock sending side LSI for initialization. Then, the sending control section 11 defines the frequency of the PLL of the clock oscillating section 12. Additionally, the sending control section 11 outputs an electric potential correcting command to the electric potential correcting section 14 as electric potential correction control signal. The sending control section 11 has an electric power source monitoring element having the function of a timer and is adapted to generate an electric potential correction start timing signal that becomes High after a predetermined period of time. On the other hand, the receiving control section 21 of the clock receiving side LSI 21 outputs a Ready signal to the clock sending side LSI 1. The sending control section 11 generates an electric potential correction end timing signal that becomes High when the Ready signal is received. Additionally, the sending control section 11 outputs the result of the EXCLUSIVE-OR operation conducted on the electric potential correction start timing signal and the electric potential correction end timing signal to the electric potential correcting section 14 as electric potential correction control signal.

FIG. 2 is a timing chart of the operation of generating the potential correction control signal according to the present invention. In FIG. 2, the horizontal axis represents time and the vertical axis represents electric potential. The electric potential correcting start timing signal, the electric potential correction end timing signal and the electric potential correction control signal are shown in FIG. 2 in the mentioned order from above. The period during which the electric potential correction control signal is High is referred to as electric potential correction period and the period during which the clock oscillating section 12 outputs a outgoing clock signal after the electric potential correction period is referred to as clock operation period.

Now, the operation of the embodiment in an electric potential correction period will be described below. The electric potential correcting section 14 corrects electric potentials of the pair of differential clock signals coming from the differential clock sending section 13 according to the electric potential correction control signal and outputs the outcome of the correction to the clock receiving side LSI 2 as differential clock signals Q, /Q. Note that the electric potential correcting section 14 corrects the electric potentials so as to reduce the difference of the electric potentials of the differential clock signals Q and /Q in the electric potential correction period.

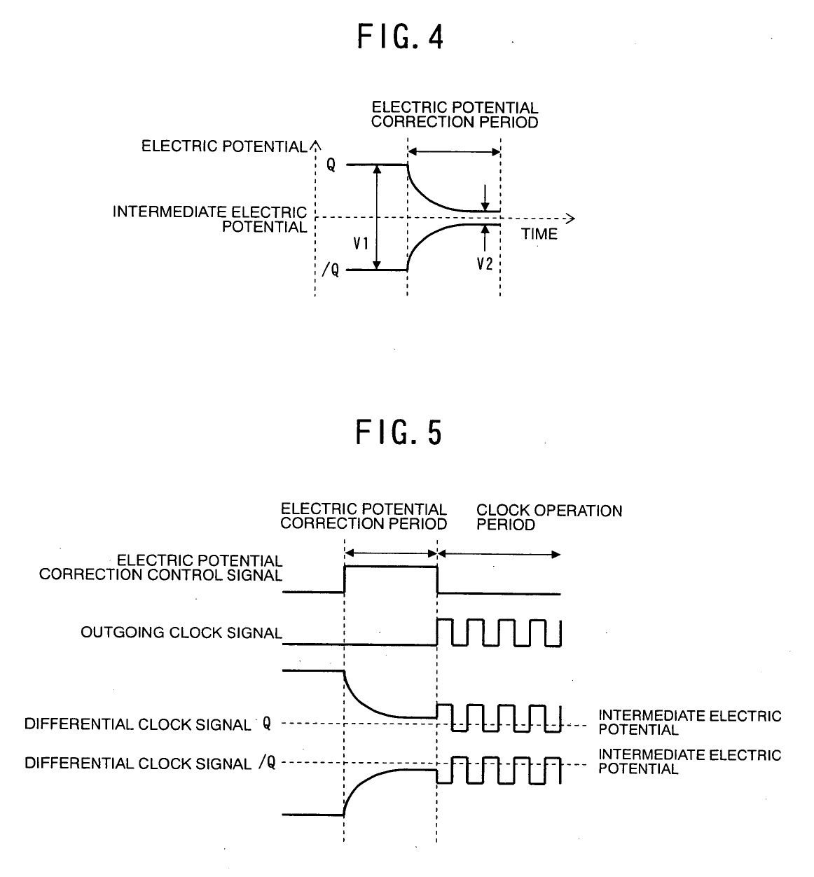

FIG. 3 is a schematic circuit diagram of the potential correcting section of the first embodiment. As shown in FIG. 3, the electric potential correcting section 14 is typically realized by a transistor (Tr31). The transistor becomes ON in the electric potential correction period by the electric potential correction control signal from the sending control section 11 so that the difference of the electric potentials of the pair of differential clock signals Q and /Q comes close to 0. FIG. 4 is a schematic illustration of waveforms showing the potential difference of the differential clock signals in the electric potential correction period of the first embodiment. In FIG. 4, the horizontal axis represents time and the vertical axis represents electric potential. The electric potential difference V1 of the differential clock signals Q, /Q before the electric potential correction period is reduced to V2 after the electric potential correction period. In other words, the electric potential correction period should be such that V2 is reduced to a sufficiently small value after that period. Additionally, if the value of V2 becomes too small to give rise to a problem of operation error, V2 needs to satisfy the input voltage threshold value defined by the differential clock receiving section 22.

Now, the operation of the embodiment in a clock operation period will be described below. As the clock oscillating section 12 outputs a outgoing clock signal in the clock operation period that immediately succeeds an electric potential correction period, the differential clock sending section 13 converts the outgoing clock signal into a pair of differential clock signals, while the electric potential correcting section 14 outputs the input differential clock signals without doing anything about them. FIG. 5 is a timing chart of the operation of the clock sending side LSI of the first embodiment. In FIG. 5, the horizontal axis represents time and the vertical axis represents electric potential. The electric potential correction control signal output from the sending control section 11, the outgoing clock signal output from the clock oscillating section 12 and the differential cock signals Q, /Q output from the electric potential correcting section 14 are shown in FIG. 5 in the mentioned order from above. Both of the electric potentials of Q and /Q come close to an intermediate potential at the end of the electric potential correction period and become stable at or near the intermediate electric potential in the clock operation period.

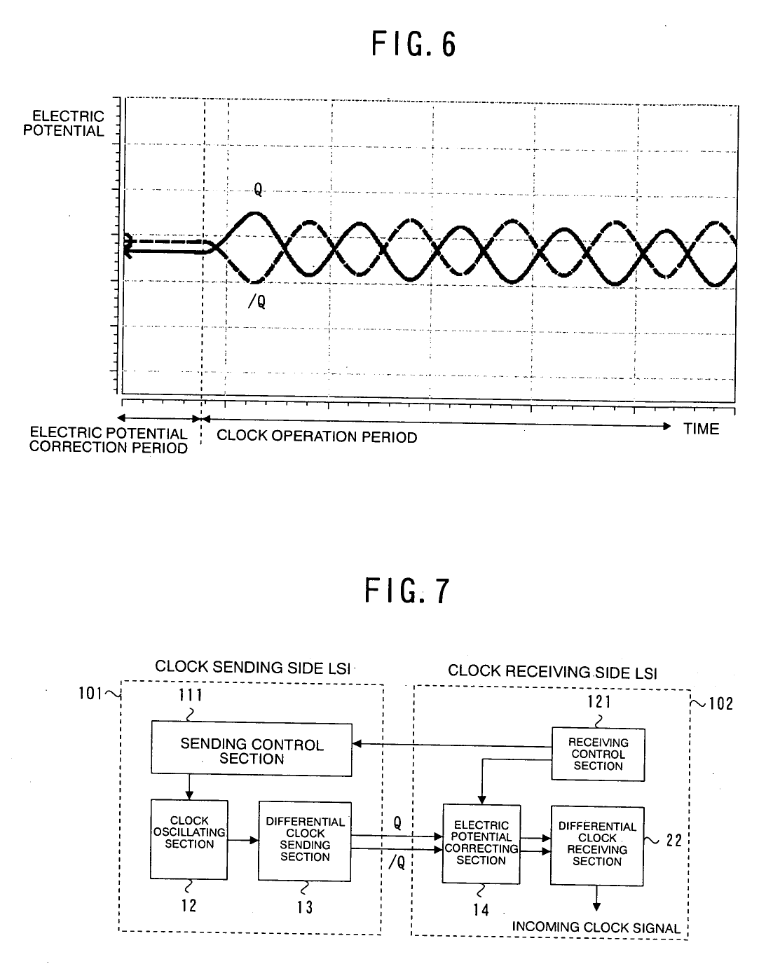

FIG. 6 is a schematic illustration of the waveforms of the differential clock signals input to the differential clock receiving section of the first embodiment in a clock operation period. As in the case of FIG. 14, the waveforms are obtained by a simulation of the input waveforms of the differential clock receiving section 22 at the clock receiving side LSI 2. By comparing with FIG. 14, it will be seen that the electric potential difference between Q and /Q at the time of the end of an electric potential correction period is small and the waveforms are stable at the beginning of the immediately succeeding clock operation period to prove that their duties and phases are stable.

While an electric power source monitoring element having the function of a timer is utilized by the sending control section 11 to control the timing of the electric potential correction start timing signal in the above described embodiment, a control signal for an initialization process may alternatively be used. Still alternatively, a selection control signal of the PLL may be used. While a Ready signal of the receiving control section 21 is utilized by the sending control section 11 to control the timing of the electric potential correction end timing signal in the above described description, an Enable signal of the receiving control section 21 may alternatively be used. Still alternatively, an Enable signal of the sending control section 11 may be used. Then, the receiving control section 21 may not be necessary.

### Second Embodiment

In this embodiment, the electric potential correcting operation is conducted by the receiving side to obtain advantages similar to those of the first embodiment. FIG. 7 is a schematic block diagram of the second embodiment of differential clock transmission apparatus according to the invention, showing the configuration thereof. In FIG. 7, the components that are identical with or equivalent to the corresponding ones of FIG. 1 are denoted respectively by the same reference symbols and will not be described here any further. By comparing with the differential clock transmission apparatus of FIG. 1, it will be seen that the differential clock transmission apparatus of FIG. 7 comprises a clock sending side LSI 101 in place of the clock sending side LSI 1 and a clock receiving side LSI 102 in place of the clock receiving side LSI 2.

By comparing with the clock sending side LSI 1, it will be seen that the clock sending side LSI 101 of FIG. 7 has a sending control section 111 in place of the sending control section 11 and hence does not require any electric potential correcting section 14. Again, by comparing with the clock receiving side LSI 2, it will be seen that the clock receiving side LSI 102 of FIG. 7 has a receiving side control section 121 in place of the receiving control section 21 and additionally has an electric potential correcting section 14. Thus, while this embodiment operates same as the first embodiment, by comparing with the first embodiment, not the sending side but the receiving side has the electric potential correcting section 14 and hence the receiving control section 121 outputs an electric potential correction control signal to the electric potential correcting section 14 like the sending control section 11 of the first embodiment. The sending control section 111 selects the frequency of the clock oscillating section 12 according to the electric potential correction control signal and the like from the receiving control section 121.

### Third Embodiment

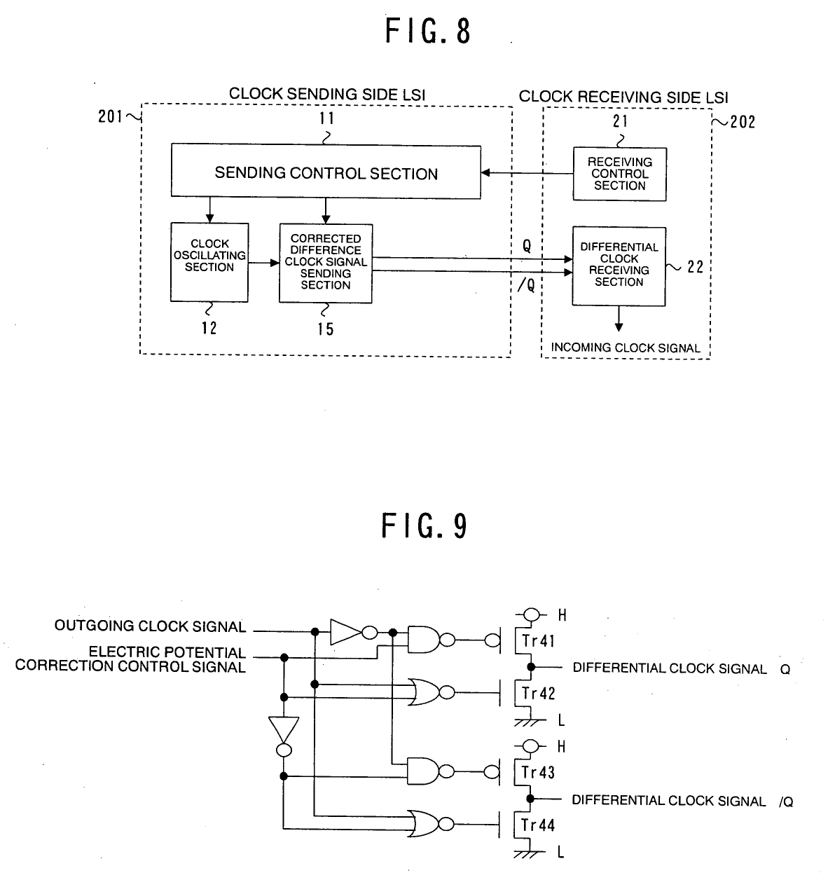

In this embodiment, while the electric potential correcting operation is conducted by the sending side, the sending side is so configured as to have both the function of converting an outgoing clock signal into a pair of differential clock signals and the electric potential correcting function to obtain advantages similar to those of the above described embodiments. FIG. 8 is a schematic block diagram of the third embodiment of differential clock transmission apparatus according to the invention, showing the configuration thereof. In FIG. 8, the components that are identical with or equivalent to the corresponding ones of FIG. 1 are denoted respectively by the same reference symbols and will not be described here any further. By comparing with the differential clock transmission apparatus of FIG. 1, it will be seen that the differential clock transmission apparatus of FIG. 8 comprises a clock sending side LSI 201 in place of the clock sending side LSI 1 and a clock receiving side LSI 202 in place of the clock receiving side LSI 2. By comparing with the clock sending side LSI 1, it will be seen that the clock sending side LSI 201 of FIG. 8 has a corrected differential clock sending section 15 in place of the clock sending section 13 and the electric potential correcting section 14.

FIG. 9 is a schematic block diagram of the corrected differential clock sending section of the third embodiment, showing the configuration thereof. Referring to FIG. 9, the corrected differential clock sending section 15 has four transistors (Tr41, Tr42, Tr43, Tr44), of which Tr41 and Tr43 are connected to electric potential H, which is a High potential, while the transistors Tr42 and Tr44 are connected to electric potential L, which is a Low potential.

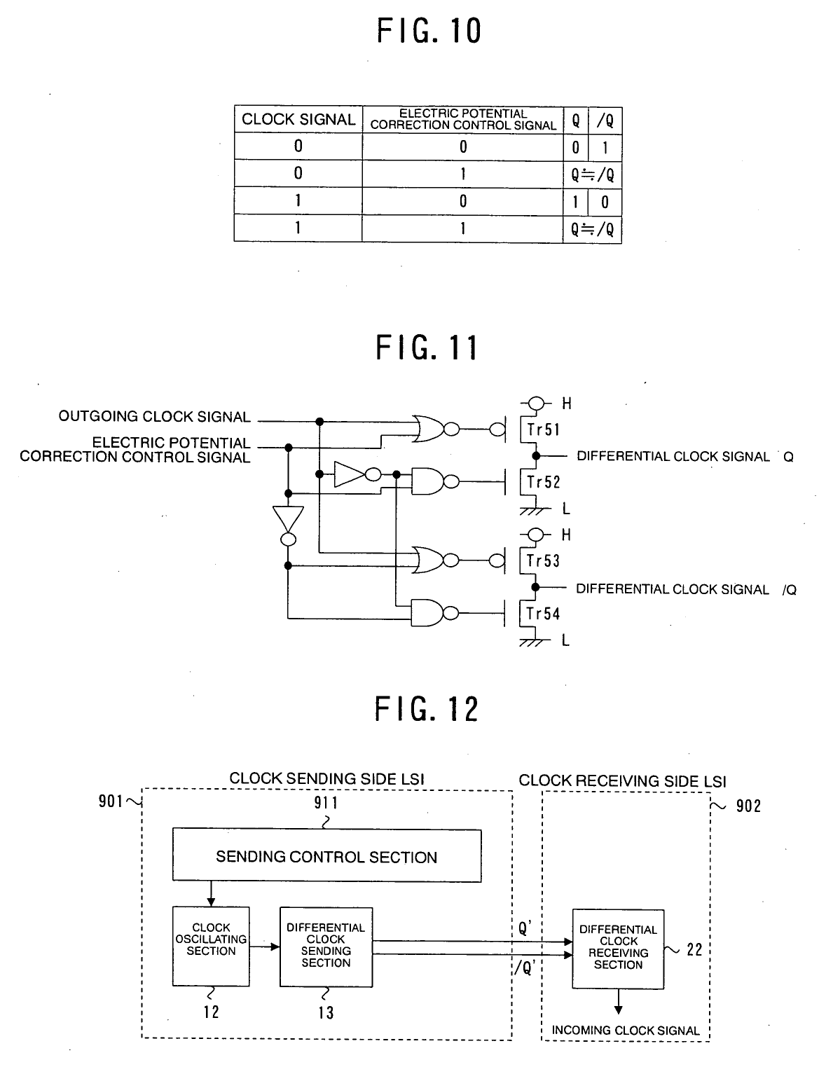

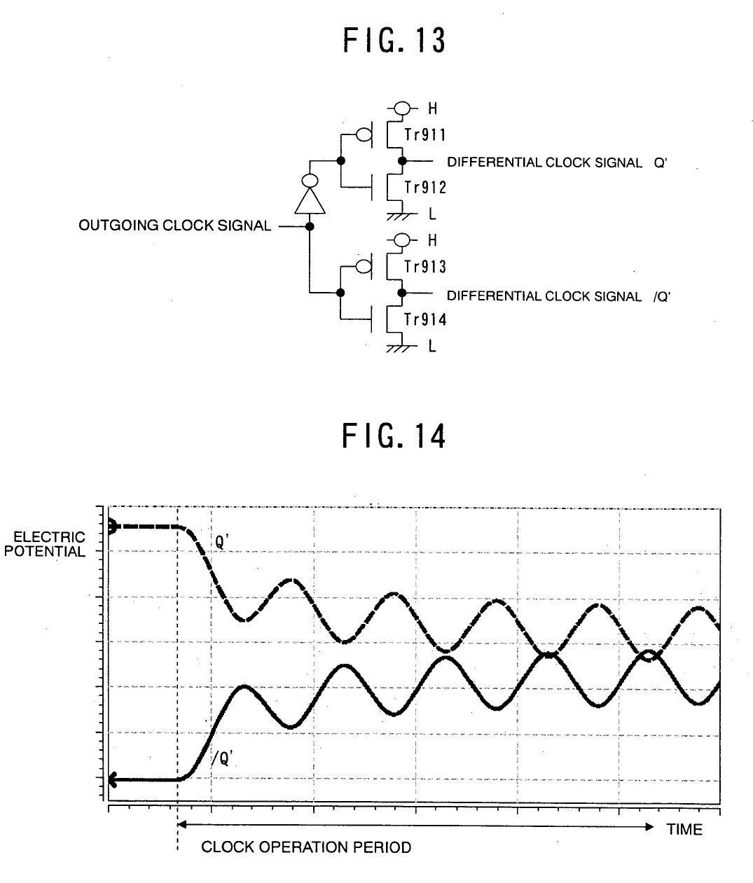

The corrected differential clock sending section 15 generates a pair of differential clock signals Q, /Q on the basis of the outgoing clock signal from the clock oscillating section 12 and the electric potential correction control signal from the sending control section 11. The circuit of FIG. 9 operates to turn OFF all the transistors in the electric potential correction period, when the electric potential of Q and that of /Q become substantially equal to each other. FIG. 10 is a schematic illustration of the operation of the corrected differential clock sending section of the third embodiment. In the electric potential correction period, when the electric potential correction control signal is at 1 (High), the electric potential of Q and that of /Q are substantially equal to each other. In the clock operation period, when the electric potential correction control signal is at 0 (Low), the electric potential of Q follows the outgoing clock signal and that of /Q is equal to the inverted electric potential of Q.

FIG. 11 is a schematic block diagram of an alternative corrected differential clock sending section of the third embodiment, showing the configuration thereof. In this arrangement, the corrected differential clock sending section 15 has four transistors (Tr51, Tr52, Tr53, Tr54), of which Tr51 and Tr53 are connected to electric potential H, which is a High potential, while the transistors Tr52 and Tr54 are connected to electric potential L, which is a Low potential. The circuit of FIG. 11 operates to turn ON all the transistors in the electric potential correction period, when the electric potential of Q and that of /Q become substantially equal to each other. The outputs of Q, /Q for the outgoing clock signal and the input of the electric potential correction control signal are same as those listed in FIG. 10.

A differential clock sending apparatus according to the invention corresponds to the clock sending side LSI of any of the above-described embodiment. A differential clock receiving apparatus according to the invention corresponds to the clock receiving side LSI of any of the above-described embodiment. A control section for the purpose of the invention refers to the sending control section of the first embodiment, the receiving control section of the second embodiment and the sending control section of the third embodiment.

What is claimed is:

1. A differential clock transmission apparatus adapted to convert an outgoing clock signal into a pair of differential clock signals for transmission and also convert a pair of differential clock signals into a single incoming clock signal, said apparatus comprising:
a control section that specifies an electric potential correction period that is a predetermined period before utilizing the incoming clock signal;
a differential clock sending section that converts a single outgoing clock signal into a pair of differential clock signals;
an electric potential correcting section that reduces the potential difference of the pair of differential clock signals within the electric potential correction period; and
a differential clock signal receiving section that converts a pair of differential clock signals into a single incoming clock signal.

2. The apparatus according to claim 1, wherein the electric potential correcting section includes transistors that connect the signal lines of the pair of differential clock signals and reduce the potential difference by turning ON the transistors during the electric potential correction period.

3. The apparatus according to claim 1, wherein
the pair of differential clock signals has two states including a first electric potential and a second electric potential lower than the first electric potential; and
each of the signal lines of the pair of differential clock signals in the electric potential correcting section is connected to the first electric potential and the second electric potential by way of the respective transistors so that both of the paired differential clock signals show an electric potential near the middle of the first electric potential and the second electric potential by turning OFF all the transistors during the electric potential correction period.

4. The apparatus according to claim 1, wherein
the pair of differential clock signals has two states including a first electric potential and a second electric potential lower than the first electric potential; and
each of the signal lines of the pair of differential clock signals in the electric potential correcting section is connected to the first electric potential and the second electric potential by way of the respective transistors so that both of the paired differential clock signals show an electric potential near the middle of the first electric potential and the second electric potential by turning ON all the transistors during the electric potential correction period.

5. A differential clock sending apparatus adapted to convert an outgoing clock signal into a pair of differential clock signals and send them to an outside apparatus, said apparatus comprising:
a control section that specifies an electric potential correction period that is a predetermined period before the outside apparatus utilizes the differential clock signals;
a differential clock sending section that converts a single outgoing clock signal into a pair of differential clock signals; and
an electric potential correcting section that reduces the potential difference of the pair of differential clock signals within the electric potential correction period.

6. A differential clock receiving apparatus adapted to convert a pair of differential clock signals received from the outside into a single incoming clock signal, said apparatus comprising:
a control section that specifies an electric potential correction period that is a predetermined period before utilizing the incoming clock signal;
an electric potential correcting section that reduces the potential difference of a pair of externally input differential clock signals within the electric potential correction period; and
a differential clock signal receiving section that converts the pair of differential clock signals into a single incoming clock signal.

7. A differential clock transmission method adapted to convert an externally input outgoing clock signal into a pair of differential clock signals for transmission and also convert a pair of differential clock signals into a single incoming clock signal, said method comprising:
specifying an electric potential correction period that is a predetermined period before utilizing the incoming clock signal;
converting a single outgoing clock signal into a pair of differential clock signals;
reducing the potential difference of the pair of differential clock signals within the electric potential correction period; and
converting a pair of differential clock signals into a single incoming clock signal.

8. The method according to claim 7, wherein the potential difference is reduced by connecting the signal lines of the pair of differential clock signals during the electric potential correction period.

9. The method according to claim 7, wherein
the pair of differential clock signals has two states including a first electric potential and a second electric potential lower than the first electric potential; and
each of the signal lines of the pair of differential clock signals is insulated from the first electric potential and the second electric potential so that both of the paired differential clock signals show an electric potential near the middle of the first electric potential and the second electric potential during the electric potential correction period.

10. The method according to claim 7, wherein
the pair of differential clock signals has two states including a first electric potential and a second electric potential lower than the first electric potential; and
each of the signal lines of the pair of differential clock signals is connected to the first electric potential and the second electric potential in the potential correcting step so that both of the paired differential clock signals show an electric potential near the middle of the first electric potential and the second electric potential during the electric potential correction period.
